(19) United States
(12) Patent Application Publication
(10) Pub. No.: US 2023/0049478 A1
(43) Pub. Date: Feb. 16, 2023

(54) POWER SUPPLY UNITS

(71) Applicant: HEWLETT-PACKARD DEVELOPMENT COMPANY, L.P., Spring, TX (US)

(72) Inventors: Po Cheng Liao, Taipei City (TW); Ching Hsiung Yang, Taipei City (TW); Hsin Tso Lin, Taipei City (TW); Chien-Hao Lu, Taipei City (TW)

(73) Assignee: HEWLETT-PACKARD DEVELOPMENT COMPANY, L.P., Spring, TX (US)

(21) Appl. No.: 17/796,859

(22) PCT Filed: Jan. 31, 2020
(86) PCT No.: PCT/US2020/016239

§ 371 Date: Aug. 1, 2022

(51) Int. Cl. G06F 1/3296; G06F 1/3287

(52) U.S. Cl. CPC G06F 1/3296; G06F 1/3287

(57) ABSTRACT

Examples of power management apparatuses, computing devices, and methods for disabling a phase of a power supply unit based on a power mode of a computing device are described herein. In an example, upon receiving an indication of the power mode of the computing device from a switching circuit, the power supply unit may disable the phase.

### BACKGROUND

Power supply units provide electrical power to various electronic devices, such as computers, printers, scanners, etc. for operation of the electronic devices. The power supply units may provide the electrical power as a single power phase or multiple power phases.

### BRIEF DESCRIPTION OF FIGURES

The detailed description is provided with reference to the accompanying figures, wherein:

FIG. 1 illustrates a power management apparatus for regulating phases of a power supply unit based on a mode of operation of an electronic device, according to an example;

FIG. 2 illustrates a circuit diagram of a power management apparatus for regulating phases of a power supply unit based on a mode of operation of an electronic device, according to an example;

FIG. 3 illustrates a computing device for regulating phases of a multi-phase power supply unit based on a mode of operation of the computing device, according to an example;

FIG. 4 illustrates a circuit diagram of a computing device for regulating phases of a multi-phase power supply unit based on a mode of operation of the computing device, according to an example;

FIG. 5 illustrates a method for regulating phases of a power supply unit based on a mode of operation of an electronic device, according to an example; and

FIG. 6 illustrates a method for regulating phases of a power supply unit based on a mode of operation of an electronic device.

### DETAILED DESCRIPTION

Electronic devices, such as a computer, a printer, a scanner, other electrically powered digital device, may be coupled to a power supply unit for providing power for operation of the electronic devices. For example, the power supply unit may be a switched mode power supply that may include regulating units that are turned ON and OFF to supply power to the electronic device.

As the electronic device may have various modes of operation, the power supply unit may supply multiple power phases to the electronic device for being used based on the modes of operation. Examples of the modes of operation may include, but are not limited to, a normal power mode, a low power mode, and a high-power mode. The normal power mode is a working state of the electronic device. During the low power mode, the electronic device may power down certain functional blocks that are inactive.

In absence of any interaction between the power supply unit and a processor of the electronic device, the power supply unit may be unaware of any change in mode of operation of the electronic device. As a result, the power supply unit may continue to supply the multiple power phases to the electronic device. This may cause the regulating units to switch at a same frequency irrespective of the mode of operation of the electronic device. This may result in same switching losses during the low power mode as well as the switching losses during the normal power mode of the electronic device. During the low power mode of operation, since less current is drawn, the switching may become inefficient when compared to a total current generated, thereby affecting the power supply unit.

The present subject matter discloses example approaches for disabling a phase of a power supply unit based on a mode of operation of an electronic device. For example, the present subject matter may include a power supply unit that may be coupled to a switching circuit. The power supply unit may provide multiple power phases to an electronic device. The multiple power phases may indicate different wattages that may be supplied to the electronic device.

The switching circuit may receive a signal indicating a low power mode of the electronic device. The switching circuit may provide a feedback to the power supply unit in response to the signal. Upon receiving the feedback signal, the power supply unit may disable a subset of power phases from the multiple power phases. As a result, the power supply unit may output a voltage corresponding to the low power mode of the electronic device.

Accordingly, the present subject matter facilitates in reducing the switching losses, since the regulating units of the power supply unit may switch at different frequencies, based on a mode of operation of the electronic device. Further, the switching circuit coupled between the electronic device and the power supply unit may gain leverage of an existing power line to communicate with the power supply unit. As a result, the present subject matter enhances an efficiency of the electronic device and is cost-effective.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

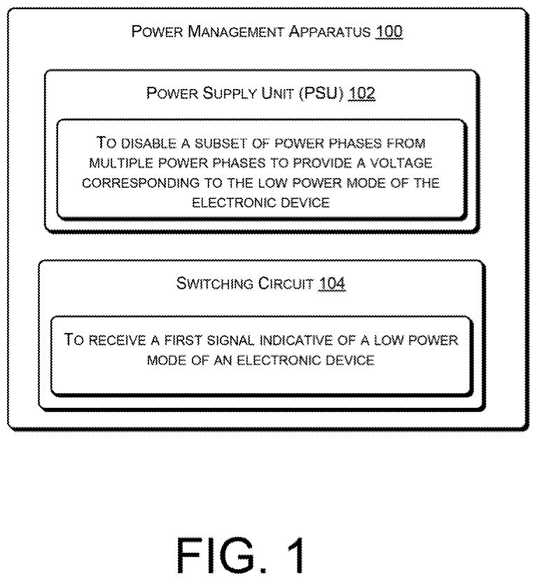

The manner in which the power management apparatus, the computing device, and the method are implemented are explained in detail with respect to FIGS. 1-6. While aspects of described power management apparatus, computing device, and method can be implemented in any number of different electronic devices, environments, and/or implementations, the examples are described in the context of the following system(s). It is to be noted that drawings of the present subject matter shown here are for illustrative purposes and are not drawn to scale.

FIG. 1 illustrates a power management apparatus 100 for regulating phases of a power supply unit 102 based on a mode of operation of an electronic device (not shown), according to an example. The power supply unit 102 may supply electrical power to the electronic device. For example, the power supply unit 102 may be a switched mode power supply. The power supply unit 102 may convert alternating current into direct current before supplying to the electronic device. To ensure that the electronic device operates effectively, the power supply unit 102 may provide a constant voltage to the electronic device. In an example implementation, the power supply unit 102 may provide multiple power phases to the electronic device. For example, a power phase may be a current or voltage along a power line. Accordingly, the power supply unit 102 may provide different voltages, such as 3.3 volts, 5 volts, and 12 volts to the electronic device.

The power management apparatus 100 may also include a switching circuit 104 that may be coupled to the power supply unit 102. The switching circuit 104 may be used for being coupled to the electronic device. Examples of the electronic device may include, but are not limited to, a computer, a printer, and a scanner. The switching circuit 104 may facilitate in controlling the supply of power from the power supply unit 102 to the electronic device.

In an example implementation, the switching circuit 104 may receive a first signal from the electronic device. The first signal may be indicative of a low power mode of the electronic device. For example, when a desktop personal computer (PC) may go in a sleep mode or a hibernation mode, the desktop PC may become inactive. As a result, various components of the desktop PC may not consume any power. This may cause a microprocessor of the desktop PC to indicate the low power mode of the desktop PC to the switching circuit 104. The microprocessor may provide the indication as the first signal.

As the switching circuit 104 is coupled to the power supply unit 102, the switching circuit 104 may interact with the power supply unit 102 to control the power being supplied to the desktop PC. Accordingly, the power supply unit 102 may, due to the low power mode of the desktop PC, disable a subset of power phases from the multiple power phases.

The disabling of the power phases based on a mode of operation of the electronic device may facilitate in reducing any switching losses that may occur when the power supply unit 102 may continue to provide the subset of power phases to the electronic device. In addition, the present subject matter provides flexibility to control multiple power phases of the power supply unit, thereby resulting in enhancing an efficiency of the power supply unit.

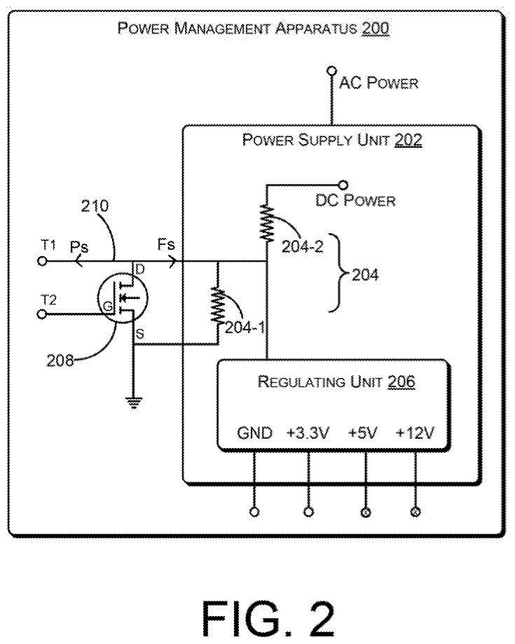

FIG. 2 illustrates a circuit diagram of a power management apparatus 200 for regulating phases of a power supply unit 202 based on a mode of operation of an electronic device (not shown), according to an example. In an example, the power management apparatus 200 may be similar to the power management apparatus 100. The power supply unit 202 may be similar to the power supply unit 102. The power supply unit 202 may be a switched mode power supply (SMPS) to convert alternating current (AC) voltage into direct current (DC) voltage for being supplied to the electronic device. For example, the power supply unit 202 may include a rectifier (not shown) to convert the AC voltage received from a main power supply into DC voltage for being used by the electronic device.

The power supply unit 202 may also include a voltage dividing circuit 204 coupled to a regulating unit 206. The voltage dividing circuit 204 may provide phase information to the electronic device and to output a voltage to the regulating unit 206. For example, the voltage dividing circuit 204 may provide identification information pertaining to different phases supplied by the power supply unit 202. Each power phase may supply a portion of a total current output of the power supply unit 202. In an example, each power phase may be designated a voltage for being supplied to the electronic device. For example, the power supply unit 202 may include three phases designated to supply 3.3 volts, 5 volts, and 12 volts to the electronic device.

In addition, the phase information provided by the voltage dividing circuit 204 may include a status of the different power phases of the power supply unit 202. For example, the voltage dividing circuit 204 may inform the electronic device about various power phases of the power supply unit 202 that are available or unavailable to the electronic device. In an example, the voltage dividing circuit 204 may provide the information pertaining to the power phases through a terminal T1. The voltage dividing circuit 204 may provide a power status signal ‘Ps’ at Terminal T1.

In an example, the voltage dividing circuit 204 may include a first resistor 204-1 and a second resistor 204-2 that may be connected in series. The voltage dividing circuit 204 may distribute an input voltage between the first resistor 204-1 and the second resistor 204-2. As a result, the voltage dividing circuit 204 may output a voltage that may be smaller than the input voltage. For example, if the input DC voltage of the voltage dividing circuit 204 is 5 volts, the voltage dividing circuit 204 may output a DC voltage of 3 volts for being supplied to the regulating unit 206.

The regulating unit 206 may regulate or control the multiple power phases that are being supplied to the electronic device. In an example, the regulating unit 206 may include switching devices (not shown), such as transistors that are turned ON and OFF to supply power to the electronic device. The regulating unit 206 may output different voltages, such as 3.3 volts, 5 volts, and 12 volts.

In an example implementation, the power management apparatus 200 may also include a switching circuit 208. The switching circuit 208 may be similar to the switching circuit 104. The switching circuit 208 may be coupled to the power supply unit 202. Although the switching circuit 208 is depicted to be external to the power supply unit 202, the switching circuit 208 may be integral to the power supply unit 202. In an example, the switching circuit 208 may be a Metal-Oxide Semiconductor Field Effect Transistor (MOSFET).

As is depicted in FIG. 2, the MOSFET 208 may include a gate terminal (G), a drain terminal (D), and a source terminal (S). The gate terminal ‘G’ of the MOSFET 208 may be coupled to the electronic device, such as through terminal T2. For example, the gate terminal ‘G’ of the MOSFET 208 may receive the first input signal from a controller (not shown) of the electronic device. Further, the drain terminal ‘D’ of the MOSFET 208 may be coupled to a path 210 for connecting the voltage regulating circuit 204 with the electronic device. The source terminal ‘S’ of the MOSFET 208 may be coupled to ground and may be in parallel to the second resistor 204-2.

In operation, the first signal received at the gate terminal ‘G’ may turn ON the MOSFET 208. For example, in the low power mode, the electronic device may provide a HIGH input signal at the gate terminal ‘G’. As a result, the drain terminal ‘D’ and the source terminal ‘S’ may get coupled to the ground to provide a shortest path for flow of current. The switching circuit or the MOSFET 208 may provide a feedback signal ‘F_{S}’ to override the output from the voltage dividing circuit 204 to the regulating unit 206 of the power supply unit 202. For example, when a HIGH input signal is received at the gate terminal ‘G’, the MOSFET 208 may provide a LOW output signal to the regulating unit 206.

In response to the feedback signal ‘F_{S}’, the regulating unit 206 may disable a subset of power phases of the power supply unit 202. For example, the regulating unit 206 may disable the power phases supplying 5 volts and 12 volts power to the electronic device. Thus, the power supply unit 202 may output one phase of 3.3 volts to the electronic device, upon receiving an indication of the low power mode of the electronic device. In the low power mode, a quiescent current of the regulating unit 206 may get reduced since switching devices (not shown) of the regulating unit 206 are OFF. The quiescent current may be the current drawn by the regulating unit 206 when the regulating unit 206 may be inactive. As the regulating unit 206 do not consume any power, efficiency of the regulating unit 206 and in turn of the power supply unit 202 may get enhanced.

In an example implementation, the switching circuit 208 of the power management apparatus 200 may receive a second signal from the electronic device. The second signal may be indicative of a high-power mode of the electronic device. For example, when a laptop computer may be in a working state, the laptop computer may become active. As a result, various components of the laptop computer may consume power. This may cause a microprocessor of the laptop computer to indicate the high-power mode of the laptop computer to the switching circuit 208. The microprocessor may provide the indication as the second signal.

The second signal received at the gate terminal ‘G’ may turn OFF the MOSFET 208. For example, in the high-power mode, the electronic device may provide a LOW input signal at the gate terminal ‘G’. As a result, the drain terminal ‘D’ and the source terminal ‘S’ may get disconnected from the ground. In the present scenario, the switching circuit 208 may provide another signal ‘I_{S}’ to initiate the output from the voltage dividing circuit 204 to the regulating unit 206 of the power supply unit 202. For example, when a LOW input signal is received at the gate terminal ‘G’, the MOSFET 208 may provide a HIGH output signal to the regulating unit 206.

In response to the signal ‘I_{S}’, the regulating unit 206 may enable all power phases of the power supply unit 202. For example, the regulating unit 206 may enable all the power phases supplying 3.3 volts, 5 volts and 12 volts power to the electronic device, upon receiving an indication of the high-power mode of the electronic device.

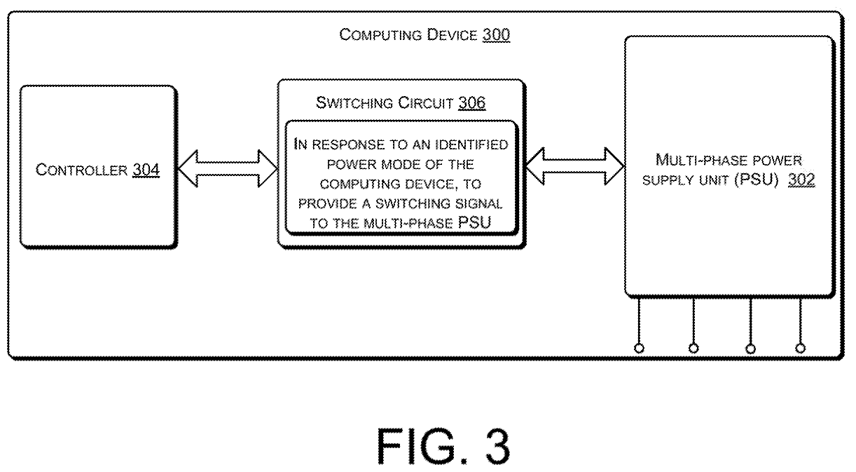

FIG. 3 illustrates a computing device 300 for regulating phases of a multi-phase power supply unit (PSU) 302 based on a mode of operation of the computing device 300, according to an example. Examples of the computing device 300 may include an All-in-One (AiO) personal computer (PC), a full-sized desktop PC, a laptop computer, and so on. The multi-phase PSU 302 may supply electrical power to the computing device 300. For example, the multi-phase PSU 302 may be a switched mode power supply for supplying different voltages, such as 3.3 volts, 5 volts, and 12 volts to the computing device 300.

The computing device 300 may also include a controller 304. The controller 304 may identify a power mode of the computing device 300. Based on the identified power mode of the computing device 300, the controller 304 may have a broad range of current demand from very high peak currents to relatively low quiescent current. For example, during a low power mode, the controller 304 may deactivate various functional blocks of the computing device 300, thereby consuming less power. The controller 304 may be implemented as an embedded controller, a microcontroller, a microprocessor, a functional block, logic, or other circuit or collection of circuits capable of performing the functions described herein. The controller 304 may be operably coupled to the multi-phase PSU 302 of the computing device 300. Therefore, in response to any input regarding change in mode of operation of the computing device 300, the multi-phase PSU 302 may selectively enable or disable power phases.

In an example, the computing device 300 may also include a switching circuit 306 that may be coupled to the multi-phase PSU 302 and the controller 304. In response to the identified power mode of the computing device 300, the switching circuit 306 may provide a switching signal to the multi-phase PSU 302. For example, the switching signal may be indicative of a low power mode or a high-power mode of the computing device 300.

As the switching circuit 306 may control the supply of power to the computing device 300, the switching circuit 304 may provide a corresponding signal to the multi-phase PSU 302. Accordingly, the multi-phase PSU 302 may selectively enable and disable a power phase of to a voltage corresponding to the identified power mode of the computing device 300.

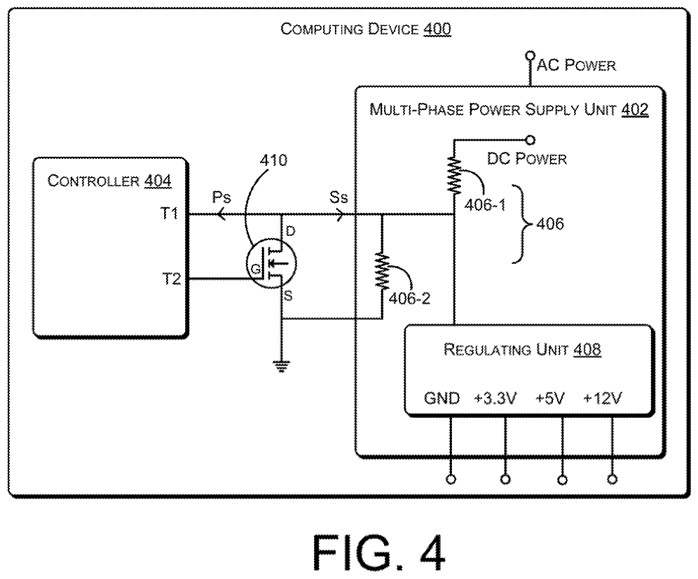

FIG. 4 illustrates a circuit diagram of a computing device 400 for regulating phases of a multi-phase power supply unit (PSU) 402 based on a mode of operation of the computing device 400, according to an example. In an example, the computing device 400 may be similar to the computing device 300. The computing device 400 may include a central processing unit (CPU) (not shown), a motherboard (not shown), and a controller 404. The controller 404 may be similar to the controller 304.

The controller 404 may identify a power mode of the computing device 400. For example, when the computing device 400 boots up, a power-on self-test (POST) sequence may be performed to check whether or not the computing device 400 is receiving power from the multi-phase PSU 402. During the POST sequence, the controller 404 may assert a power-on signal to the multi-phase PSU 402. The multi-phase PSU 402 may respond to the power-on signal with a power OK (PWOK) signal. The PWOK signal may indicate that the controller 404 has turned on the multi-phase PSU 402. As a result, power may be supplied to the rest of the computing device 400. For example, the multi-phase PSU 402 may supply multiple power phases, such as 3.3 volts, 5 volts, and 12 volts to various components, such as processors, memory and so on of the computing device 400.

The multi-phase PSU 402 may include a voltage dividing circuit 406 and a regulating unit 408. The voltage dividing circuit 406 may provide phase information to the computing device 400 and may output a voltage to the regulating unit 408. For example, the voltage dividing circuit 406 may provide details of the power phases that are enabled or disabled etc. at T1 terminal of the controller 404. The voltage dividing circuit 406 may include a first resistor 406-1 and a second resistor 406-2 coupled in series.

Further, the computing device 400 may also include a switching circuit 410. The switching circuit 410 may be similar to the switching circuit 306. In an example, the switching circuit 410 may be a Metal-Oxide Semiconductor Field Effect Transistor (MOSFET) having a gate terminal ‘G’, a drain terminal ‘D’, and a source terminal ‘S’. The switching circuit 410 may be parallel to the second resistor 406-2 of the voltage dividing circuit 406. The switching circuit 410 may control the supply of power to the computing device 400. In an example, the gate terminal ‘G’ of the MOSFET 410 may be coupled to the controller 404, such as at terminal T2. Terminal T2 may be the terminal at which the PWOK signal is received by the controller 404.

During normal power mode of the computing device 400, the voltage dividing circuit 406 may provide a power status signal ‘Ps’ at Terminal T1 of the controller 404. During the normal mode, the controller 404 may not communicate with the switching circuit 410. In an example, in a sleep mode or a hibernation mode, the computing device 400 may enter a low power mode, i.e., various components of the computing device 400 may become inactive. The controller 404 may identify that the computing device 400 has entered the low power mode. Accordingly, the controller 404 may provide a HIGH input signal at the PWOK terminal T2.

As terminal T2 is connected to the gate terminal ‘G’ of the MOSFET 410, the HIGH input signal may be received by the MOSFET 410. In response to the HIGH input signal, the MOSFET 410 may be switched ON. This may cause the drain terminal ‘D’ and the source terminal ‘S’ of the MOSFET 410 to get coupled to the ground. The switching ON of the switching circuit or the MOSFET 410 may provide a switching signal ‘S_{S}’ to the multi-phase PSU 402. The switching signal ‘S_{S}’ output by the MOSFET 410, when the HIGH input signal is provided by the controller 404, may be indicative of the low power mode of the computing device 400. In response to the switching signal ‘S_{S}’, the regulating unit 408 may disable a subset of power phases of the multi-phase PSU 402. The subset of power phases may be able to adequately cater to the power demands of the computing device 400.

In another example, the computing device 400 may enter a high-power mode, i.e., various components of the computing device 400 may demand additional power supply to perform respective operations. The controller 404 may identify the high-power mode and may provide a LOW input signal at the PWOK terminal T2.

The LOW input signal may be received by the MOSFET 410. In response to the LOW input signal, the MOSFET 410 may be switched OFF. This may cause the drain terminal ‘D’ and the source terminal ‘S’ of the MOSFET 410 to get disconnected from the ground. The switching OFF of the switching circuit or the MOSFET 410 may provide another switching signal ‘S_{S}’ to the multi-phase PSU 402. The switching signal ‘S_{S}’ output by the MOSFET 410, when the LOW input signal is provided by the controller 404, may be indicative of the high-power mode of the computing device 400. In response to the switching signal ‘S_{S}’, the regulating unit 408 may enable all power phases of the multi-phase PSU 402.

The selective enablement and disablement of the power phases may facilitate in efficiently distributing operational stress among the power phases and may enhance operational lifetime of the regulating unit 408. The selective enablement and disablement of the power phases may also facilitate in reducing thermal resistance of the regulating unit 408.

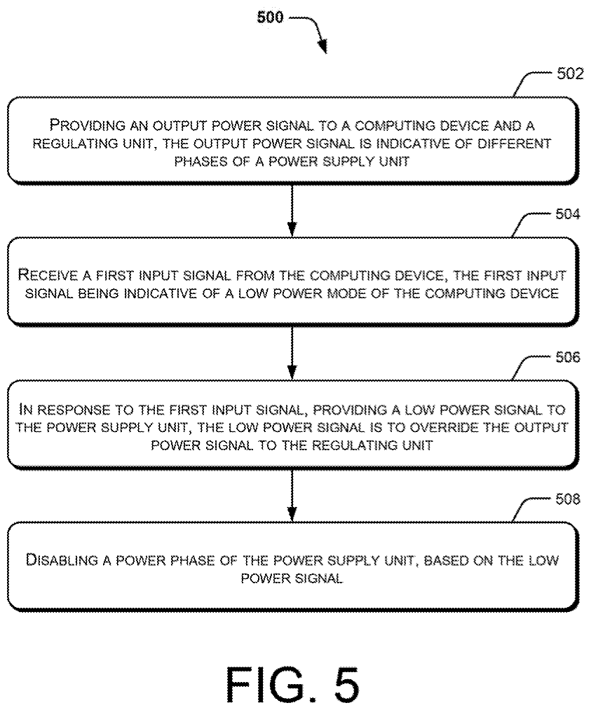

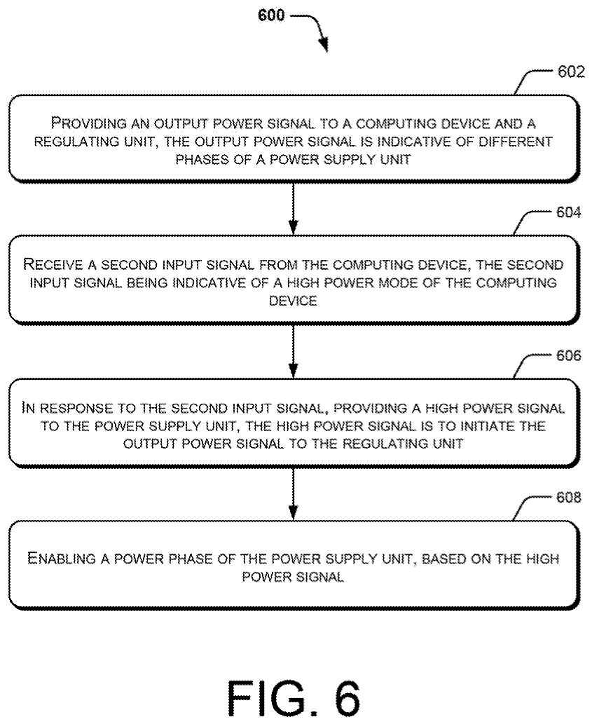

FIGS. 5 and 6 illustrate methods 500 and 600 for regulating phases of a power supply unit based on a mode of operation of an electronic device, according to examples of the present subject matter. The methods 500 and 600 may be described in the general context of computer executable instructions. The methods 500 and 600 can be implemented by processor(s) or device(s) through any suitable hardware, a non-transitory machine readable medium, or a combination thereof. Further, although the methods 500 and 600 are described in the context of a device that is similar to the computing device 300, other suitable devices or systems may be used for execution of the methods 500 and 600.

The order in which the methods 500 and 600 are described is not intended to be construed as a limitation, and any number of the described method blocks may be combined in any order to implement the methods 500 and 600, or an alternative method. In some example, blocks of the methods 500 and 600 may be executed based on instructions stored in a non-transitory computer-readable medium. The non-transitory computer-readable medium may include, for example, digital memories, magnetic storage media, such as a magnetic disks and magnetic tapes, hard drives, or optically readable digital data storage media.

Referring to FIG. 5, at block 502, an output power signal may be provided to a computing device and a regulating unit. In an example implementation, a voltage dividing circuit of the power supply unit may provide the output power signal. The voltage dividing circuit may include two resistors connected in series. The output power signal may be indicative of different power phases of the power supply unit. For example, the output power signal may provide identifiers of each phase of the power supply unit. In addition, the output power signal may provide a current status of each power phase of the power supply unit.

At block 504, the method includes receiving a first input signal from the computing device. The first input signal may be indicative of a low power mode of the computing device. In an example, the power supply unit may be coupled to a switching circuit. The switching circuit may be coupled to the computing device. For example, when the computing device operates in a low power mode, the switching circuit may receive the first input signal from a microprocessor of the computing device.

At block 506, the method includes providing a low power signal to the power supply unit, in response to the low power mode. For example, in response to the first input signal, the switching circuit may provide the low power signal to the regulating unit. In an example implementation, the low power signal may override the output power signal from the voltage dividing circuit to the regulating unit.

At block 508, the method includes disabling a power phase of the power supply unit, based on the low power signal. For example, the regulating unit may disable a subset of phases from multiple power phases output from the power supply unit.

Now referring to FIG. 6, at block 602, the method 600 includes an output power signal may be provided to a computing device and a regulating unit. In an example implementation, a voltage dividing circuit of the power supply unit may provide the output power signal. The voltage dividing circuit may include two resistors connected in series. The output power signal may be indicative of different power phases of a power supply unit. For example, the output power signal may provide identifiers of each power phase of the power supply unit. In addition, the output power signal may provide a current status of each power phase of the power supply unit.

At block 604, the method including receiving a second input signal from the computing device. The second input signal may be indicative of a high-power mode of the computing device. As mentioned with reference to FIG. 5, the power supply unit may be coupled to the switching circuit. For example, the switching circuit may be a Metal-Oxide Semiconductor Field Effect Transistor (MOSFET). Further, the switching circuit may be coupled to the computing device. For example, when the computing device operates in a high-power mode, the second input signal may be received at a gate terminal of the MOSFET.

At block 606, the method includes providing a high-power signal to the power supply unit, in response to the high-power mode of the computing device. In an example implementation, in response to the second input signal, the switching circuit may provide the high-power signal to the regulating unit. For example, the MOSFET may provide the high-power signal at a drain terminal. The high-power signal may initiate or commence the output power signal from the voltage dividing circuit to the regulating unit.

At block 608, the method includes enabling a power phase of the power supply unit, based on the high-power signal. For example, the regulating unit may, upon receiving the high-power signal, enable all phases of the power supply unit. Therefore, in the high-power mode, all power phases of the power supply unit may be made available to the computing device.

Although aspects for the present disclosure have been described in a language specific to structural features and/or methods, it is to be understood that the appended claims are not limited to the specific features or methods described herein. Rather, the specific features and methods are disclosed as examples of the present disclosure.

We claim:

1. A power management apparatus for an electronic device, the power management apparatus comprising:
a power supply unit having multiple power phases; and
a switching circuit coupled to the power supply unit and coupleable to the electronic device, the switching circuit is to control supply of power from the power supply unit to the electronic device, wherein the switching circuit is to receive a first signal indicative of a low power mode of the electronic device,
in response to the first signal, the power supply unit is to disable a subset of power phases from the multiple power phases to provide a voltage corresponding to the low power mode of the electronic device.

2. The power management apparatus as claimed in claim 1, wherein the power supply unit comprises a voltage dividing circuit to provide phase information to the electronic device and to output a voltage to the power supply unit.

3. The power management apparatus as claimed in claim 2, wherein in response to the first signal, the switching circuit is to provide a signal to override the output from the voltage dividing circuit to the power supply unit.

4. The power management apparatus as claimed in claim 3, wherein the power supply unit comprises a regulating unit to identify the signal from the switching circuit and to disable a subset of power phases, in response to the identification.

5. The power management apparatus as claimed in claim 1, wherein the switching circuit is to:
receive a second signal indicative of a high-power mode of the electronic device; and
in response to the second signal, the power supply unit is to enable the multiple power phases to provide a voltage corresponding to the high-power mode of the electronic device.

6. The power management apparatus as claimed in claim 1, wherein the switching circuit comprises a Metal-Oxide Semiconductor Field Effect Transistor (MOSFET).

7. The power management apparatus as claimed in claim 6, wherein the first signal indicative of the low power mode is received by a gate terminal of the MOSFET to switch ON the MOSFET.

8. A computing device comprising:
a controller to identify a power mode of the computing device;
a multi-phase power supply unit (PSU) operably coupled to the controller, the multi-phase PSU is to supply power to the computing device; and
a switching circuit coupled to the controller and the multi-phase PSU, wherein in response to the identified power mode of the computing device, the switching circuit is to provide a switching signal to the multi-phase PSU,
wherein in response to the switching signal, the multi-phase PSU is to selectively enable and disable a power phase to output a voltage corresponding to the identified power mode of the computing device.

9. The computing device as claimed in claim 8, wherein the switching circuit comprises a Metal-Oxide Semiconductor Field Effect Transistor (MOSFET).

10. The computing device as claimed in claim 9, wherein in response to identification of a low power mode, the controller is to provide a high input signal at a gate terminal of the MOSFET.

11. The computing device as claimed in claim 10, wherein the multi-phase PSU comprises a regulating unit to identify the switching signal and to selectively enable and disable a power phase, in response to the identification.

12. The computing device as claimed in claim 9, wherein in response to identification of a high-power mode, the controller is to provide a low input signal at a gate terminal of the MOSFET.

13. A method comprising:
providing, by a voltage dividing circuit of a power supply unit, an output power signal to a computing device and a regulating unit of the power supply unit, wherein the output power signal is indicative of different phases of the power supply unit;
receiving, by a switching circuit, a first input signal from the computing device, the first input signal being indicative of a low power mode of the computing device;
in response to the first input signal, providing a low power signal to the power supply unit, the low power signal is to override the output power signal to the regulating unit; and
disabling, by the regulating unit, a power phase of the power supply unit, based on the low power signal.

14. The method as claimed in claim 13, wherein the method comprises:
receiving, by the switching circuit, a second input signal from the computing device, the second input signal being indicative of a high-power mode of the computing device;
in response to the second input signal, providing a high-power signal to initiate the output power signal to the regulating unit; and
enabling, by the regulating unit, the power phase of the power supply unit, based on the high-power signal.

15. The method as claimed in claim 14, wherein the switching circuit is a Metal-Oxide Semiconductor Field Effect Transistor (MOSFET) and the first input signal and the second input signal are provided at a gate terminal of the MOSFET.
